(19) United States
(12) Patent Application Publication
(10) Pub. No.: US 2025/0038457 A1
(43) Pub. Date: Jan. 30, 2025

(54) CONNECTOR ASSEMBLY AND ASSEMBLY METHOD

(71) Applicant: SUMITOMO WIRING SYSTEMS, LTD., Mie (JP)

(72) Inventors: Tsuyoshi MASE, Mie (JP); Toshihiro ITO, Mie (JP); Takahiro KIKUCHI, Mie (JP); Yoichi TAKAGI, Mie (JP); Sho KOBAYASHI, Mie (JP); Toya TAICHI, Mie (JP)

(21) Appl. No.: 18/764,720

(22) Filed: Jul. 5, 2024

(30) Foreign Application Priority Data
Jul. 24, 2023 (JP) 2023-119851

(51) Int. Cl. H01R 13/629; H01R 43/00

(52) U.S. Cl. CPC H01R 13/62955; H01R 43/00

(57) ABSTRACT

A connector assembly includes a first connector and a second connector to be connected to the first connector. The first connector includes a housing and a lever to be mounted on the housing rotatably between an initial position and a completion position. The housing includes a lock receiving portion. The lever includes a lock piece for holding the lever at the initial position by locking the lock receiving portion. The lock piece is resiliently deformable. The second connector includes a releasing portion for releasing locking of the lock piece and the lock receiving portion by sliding in contact with the lock piece when the connection of the first and second connectors, is started. The lever receives a force acting in a direction opposite to a rotation direction RD from the initial position toward the completion position when the releasing portion and the lock piece slide in contact.

### CROSS-REFERENCE TO RELATED APPLICATIONS

This application is based on and claims priority from Japanese Patent Application No. 2023-119851, filed on Jul. 24, 2023, with the Japan Patent Office, the disclosure of which is incorporated herein in its entirety by reference.

### TECHNICAL FIELD

The present disclosure relates to a connector assembly and to a corresponding assembly method.

### BACKGROUND

Conventionally, a female connector described in Japanese Patent Laid-open Publication No. 2004-164933 is known as a lever-type connector for assisting a connecting operation of a connector by the rotation of a lever. The female connector described in Japanese Patent Laid-open Publication No. 2004-164933 includes a holder and a lever to be assembled with the holder. The lever includes a cantilevered resilient locking piece on an end edge part of a cam plate portion. A projection projecting outward is provided on a tip part of the resilient locking piece. The holder is formed with a rib entrance groove and a lock receiving portion to be locked to the projection. By locking the projection and the lock receiving portion, the lever is held at an initial position. A housing of a male connector to be connected to the female connector is provided with an unlocking rib. If the female connector and the male connector are lightly connected, the unlocking rib enters the rib entrance groove and comes into contact with the projection of the resilient locking piece. In this way, the locking (initial locking) of the projection and the lock receiving portion is released and a rotating operation of the lever is enabled.

### SUMMARY

However, in the above configuration, if the male connector is further pushed in a connection direction after the both connectors are lightly connected and the initial locking is released, the male connector may slightly move forward and the lever may slightly rotate although the lever is not rotated. Then, a worker may erroneously recognize that the connecting operation has been completed.

Accordingly, it is an object of the present invention to improve operability of a connector assembly.

This object is solved according to the invention by the features of the independent claims. Particular embodiments of the invention are subject of the dependent claims.

According to one aspect, there is provided a connector assembly, comprising a first connector; and a second connector to be connected to the first connector, the first connector including a housing and a displacement member to be mounted on the housing displaceably between an initial position and a completion position, the housing including at least one lock receiving portion, the displacement member including at least one lock piece for holding the displacement member at the initial position by locking the lock receiving portion, the lock piece being resiliently deformable, the second connector including at least one releasing portion for releasing locking of the lock piece and the lock receiving portion by substantially sliding in contact with the lock piece when connection of the first and second connectors is started, and the displacement member receiving a force acting in a direction substantially opposite to a displacement direction from the initial position toward the completion position when the releasing portion and the lock piece slide in contact.

According to a particular embodiment, there is provided a connector assembly with a first connector and a second connector to be connected to the first connector, the first connector including a housing and a lever to be mounted on the housing rotatably between an initial position and a completion position, the housing including a lock receiving portion, the lever including a lock piece for holding the lever at the initial position by locking the lock receiving portion, the lock piece being resiliently deformable, the second connector including a releasing portion for releasing locking of the lock piece and the lock receiving portion by sliding in contact with the lock piece when connection of the first and second connectors is started, and the lever receiving a force acting in a direction opposite to a rotation direction from the initial position toward the completion position when the releasing portion and the lock piece slide in contact.

Accordingly, the displacement (e.g. rotation or pivotal movement) of the displacement member in the displacement direction from the initial position toward the completion position can be suppressed when the locking of the lock piece and the lock receiving portion is released by the releasing portion. Therefore, operability of a connector assembly is improved.

Accordingly, the displacement (e.g. rotation or pivotal movement) of the lever in the rotation direction from the initial position toward the completion position can be suppressed when the locking of the lock piece and the lock receiving portion is released by the releasing portion.

Particularly, a direction of connecting the first and second connectors is a first direction, the first connector is connected to the second connector from one side in the first direction, the displacement member includes at least one substantially plate-like portion to be displaceably supported on a side surface of the housing and the lock piece substantially extending toward the other side in the first direction from the substantially plate-like portion with the displacement member located at the initial position, and the lock piece includes a body portion, at least one lock portion substantially projecting from or near a tip part of the body portion in a second direction intersecting with, particularly orthogonal to the first direction and at least one releasing projection projecting from the body portion toward one side in a third direction intersecting with, particularly orthogonal to both the first and second directions.

Further particularly, the releasing portion and the releasing projection substantially slide in contact, whereby the lock piece is resiliently deformed away from the side surface in the second direction.

Further particularly, the lock portion includes at least one inclined portion disposed on or near an end part on the other side in the third direction, and a projecting dimension of the inclined portion from the body portion is reduced toward the other side in the third direction.

Further particularly, a direction of connecting the first and second connectors is a first direction, the first connector is connected to the second connector from one side in the first direction, the lever includes a plate-like portion to be rotatably supported on a side surface of the housing and the lock piece extending toward the other side in the first direction from the plate-like portion with the lever located at the initial position, the lock piece includes a body portion, a lock portion projecting from a tip part of the body portion in a second direction orthogonal to the first direction and a releasing projection projecting from the tip part of the body portion toward one side in a third direction orthogonal to both the first and second directions, the releasing portion and the releasing projection slide in contact, whereby the lock piece is resiliently deformed away from the side surface in the second direction, the lock portion includes an inclined portion disposed on an end part on the other side in the third direction, and a projecting dimension of the inclined portion from the body portion is reduced toward the other side in the third direction.

Accordingly, if the lock piece is resiliently deformed to rotate about an axis extending in the first direction due to the sliding contact of the releasing portion and the releasing projection, the locking of the lock portion and the lock receiving portion is easily released.

Further particularly, a thickness of the lock piece is set to be smaller than a thickness of the plate-like portion, at least one resilient deformation space is formed on a further inner side than an outer surface of the plate-like portion, and the lock piece is resiliently deformed inside the resilient deformation space, whereby locking of the lock portion and the lock receiving portion is released.

Further particularly, a direction of connecting the first and second connectors is a first direction, the first connector is connected to the second connector from one side in the first direction, the lever includes a plate-like portion to be rotatably supported on a side surface of the housing and the lock piece extending toward the other side in the first direction from the plate-like portion with the lever located at the initial position, the lock piece includes a body portion, a lock portion projecting from a tip part of the body portion in a second direction orthogonal to the first direction and a releasing projection projecting from the tip part of the body portion toward one side in a third direction orthogonal to both the first and second directions, the releasing portion and the releasing projection slide in contact, whereby the lock piece is resiliently deformed away from the side surface in the second direction, a thickness of the lock piece is set to be smaller than a thickness of the plate-like portion, a resilient deformation space is formed on a further inner side than an outer surface of the plate-like portion, and the lock piece is resiliently deformed inside the resilient deformation space, whereby locking of the lock portion and the lock receiving portion is released.

Accordingly, since the lock piece is not disposed more outward in the second direction than the plate-like portion when being resiliently deformed, a dimension of the second connector in the second direction can be reduced when the second connector is connected to the first direction from outside.

Further particularly, the housing includes at least one protection wall substantially projecting in the second direction from the side surface and substantially extending in the first direction, and the lock piece at least partly is disposed between the protection wall and the plate-like portion substantially in the third direction.

Accordingly, by protecting the lock piece by the protection wall, it can be suppressed that the locking of the lock portion and the lock receiving portion is released.

Further particularly, the protection wall includes at least one contact portion for contacting the plate-like portion from the other side in the first direction with the displacement member, particularly the lever, located at the completion position.

Accordingly, the rotation of the lever further than the completion position in the displacement direction (e.g. rotation direction) can be suppressed by the contact of the contact portion with the plate-like portion.

Further particularly, the second connector includes at least one recess for at least partly receiving the protection wall by substantially extending in the first direction.

Accordingly, the connection of the first and second connectors can be guided by the recess receiving the protection wall.

According to another aspect, there is provided an assembly method for connecting a first connector and a second connector, in particular of a connector assembly according to the above aspect of a particular embodiment thereof, comprising the following steps: (a) mounting a displacement member on a housing of the first connector displaceably between an initial position and a completion position, wherein the housing includes at least one lock receiving portion, (b) holding or positioning the displacement member at the initial position by locking the lock receiving portion with at least one lock piece of the displacement member, wherein the lock piece is resiliently deformable, (c) providing the second connector with at least one releasing portion for releasing locking of the lock piece and the lock receiving portion by substantially sliding in contact with the lock piece when connection of the first and second connectors is started, and (d) applying a force to the displacement member, the force acting in a direction substantially opposite to a displacement direction from the initial position toward the completion position when the releasing portion and the lock piece slide in contact.

According to a particular embodiment, the first and second connectors are connected in a first direction, the first connector is connected to the second connector from one side in the first direction, the method further comprising: providing the displacement member with at least one plate-like portion to be displaceably supported on a side surface of the housing and the lock piece substantially extending toward the other side in the first direction from the plate-like portion with the displacement member located at the initial position; and providing the lock piece with a body portion, at least one lock portion substantially projecting from or near a tip part of the body portion in a second direction intersecting with, particularly orthogonal to the first direction and at least one releasing projection projecting from the body portion toward one side in a third direction intersecting with, particularly orthogonal to both the first and second directions.

According to the present disclosure, it is possible to suppress the rotation of a lever from an initial position to a completion position when a first connector and a second connector are lightly connected.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view of a second connector according to an embodiment when viewed from behind.

FIG. 2 is an enlarged perspective view of the second connector.

FIG. 3 is a view in section along A-A of FIG. 1 showing a state where a first connector and the second connector are lightly connected.

FIG. 4 is a perspective view of the first connector in a state where a lever is at an initial position.

FIG. 5 is a view of the first connector in the state where the lever is at the initial position when viewed from front.

FIG. 6 is a side view of the first connector in the state where the lever is at the initial position.

FIG. 7 is a section along B-B of FIG. 6.

FIG. 8 is a section along C-C of FIG. 6.

FIG. 9 is a view in section along C-C of FIG. 6 showing a state where a releasing portion and a releasing projection slide in contact.

FIG. 10 is a section along D-D of FIG. 7.

FIG. 11 is a view in section along D-D of FIG. 7 showing the state where the releasing portion and the releasing projection slide in contact.

FIG. 12 is a perspective view of the lever.

FIG. 13 is an enlarged perspective view of the lever.

FIG. 14 is a perspective view of the first connector in a state where the lever is at a completion position.

FIG. 15 is a view of the first connector in the state where the lever is at the completion position when viewed from front.

FIG. 16 is a side view of the first connector in the state where the lever is at the completion position.

FIG. 17 is a section along E-E of FIG. 15.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

Hereinafter, an embodiment of the present disclosure is described. The present disclosure is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different in each figure. “Orthogonal” in this specification means not only strictly orthogonal, but also substantially orthogonal within a range in which functions and effects in this embodiment are achieved.

Further, “facing each other” in this specification indicates that surfaces or members substantially are at positions in front of each other, and means not only a case where the surfaces or members are at positions perfectly in front of each other, but also a case where the surfaces or members are at positions partially in front of each other. Further, “facing each other” in this specification means both a case where another member different from two parts is interposed between the two parts and a case where nothing is interposed between the two parts.

### Embodiment

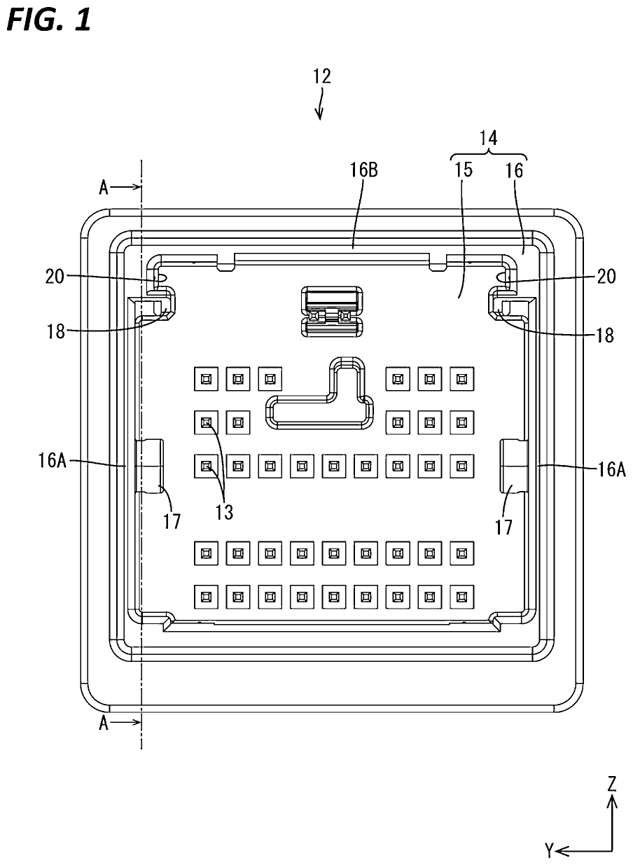

The particular embodiment of the present disclosure is described with reference to FIGS. 1 to 17. In the following description, a direction indicated by an arrow Z is referred to as an upward direction, a direction indicated by an arrow X is referred to as a forward direction and a direction indicated by an arrow Y is referred to as a leftward direction. A front-rear direction is an example of a first direction. A lateral direction is an example of a second direction. A vertical direction is an example of a third direction. Note that, for a plurality of identical members, only some members may be denoted by a reference sign and the others may not be denoted by the reference sign.

### (Connector Assembly 10)

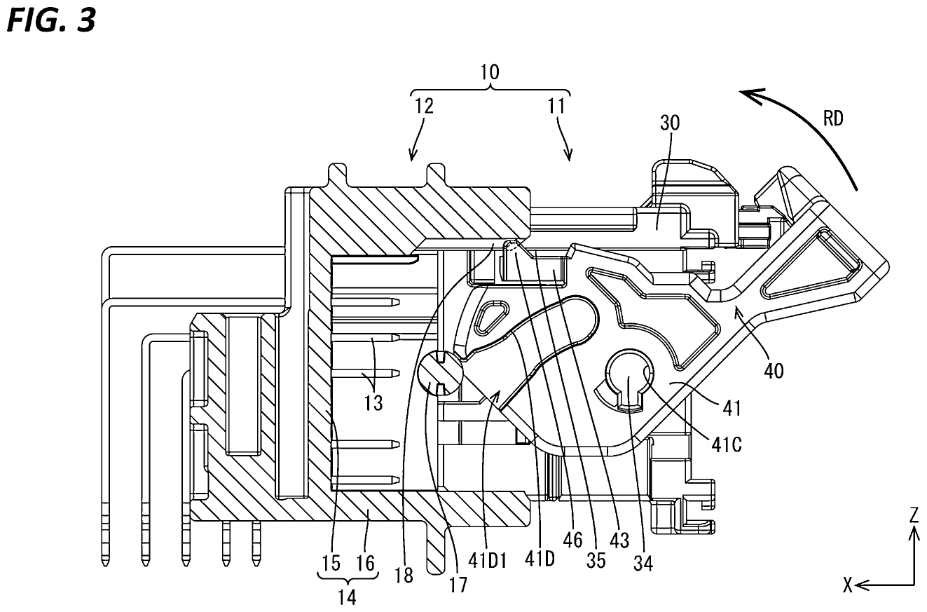

As shown in FIG. 3, a connector assembly 10 is provided at least with a first connector 11 and a second connector 12 to be connected to the first connector 11. In this embodiment, the configuration of the connector assembly 10 is described, assuming that a direction of connecting the first and second connectors 11, 12 is the front-rear direction and the first connector 11 is disposed behind (an example of one side in the first direction) the second connector 12.

### (Second Connector 12)

The second connector 12 is provided with a receptacle 14 and one or more second terminals 13. The receptacle 14 particularly at least partly is made of insulating synthetic resin.

Specifically, the receptacle 14 has a back wall 15 and/or a peripheral wall 16 substantially extending toward the first connector 11 (rearward) e.g. from the back wall 15, and substantially is open rearward. The receptacle 14 particularly is to be connected to the first connector 11 from outside.

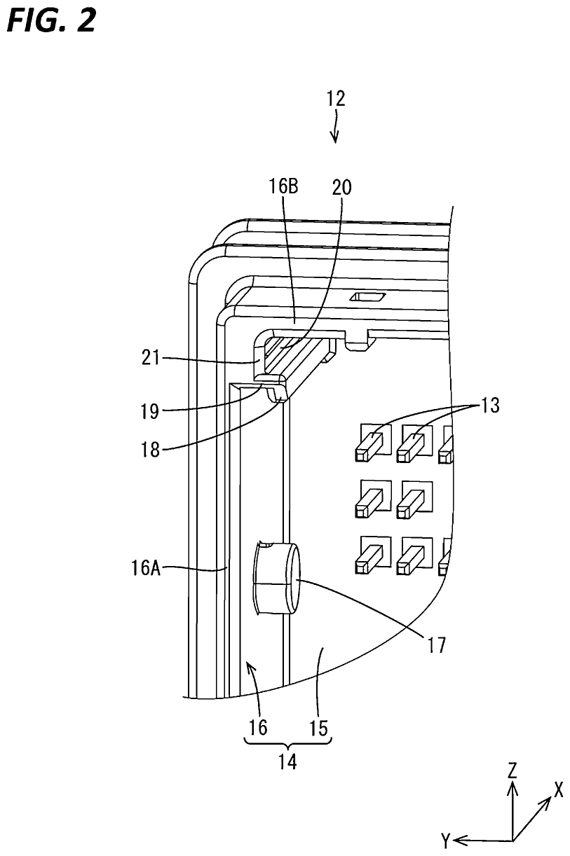

As shown in FIGS. 1 and 2, out of the peripheral wall 16, one or more side walls 16A (particularly each of a pair of side walls 16A disposed on both lateral (left and right) sides) is formed with a cam pin 17 substantially projecting inwardly of the receptacle 14 from the inner surface of the side wall 16A. The cam pin 17 particularly has a substantially cylindrical shape.

The cam pin 17 at least partly enters a cam groove 41D of a lever 40 (as an example of a displacement member) to be described later (see FIG. 3). By displacing (particularly rotating or pivoting) the lever 40 with the one or more cam pins 17 disposed inside the one or more cam grooves 41D and the cam pin(s) 17 and the one or more inner walls of the cam groove(s) 41D engaged, the connection/separation of the first connector 11 and the second connector 12 is assisted.

The second terminal 13 particularly is made of electrically conductive material (such as metal) and, as shown in FIGS. 2 and 3, particularly substantially in the form of a tab. The second terminal 13 particularly is held on the back wall 15 and/or substantially projects rearward in the receptacle 14.

### (Releasing Portions 18)

As shown in FIG. 2, the receptacle 14 is provided with one or more, particularly two releasing portions 18 particularly substantially elongated in the front-rear direction.

The releasing portion 18 is disposed while being slightly separated inwardly of the receptacle 14 from the (particularly each) side wall 16A.

Specifically, the releasing portion 18 is disposed while being slightly separated inwardly of the receptacle 14 from a ceiling wall 16B particularly disposed on an upper side, out of the peripheral wall 16.

The receptacle 14 particularly is provided with one or more projecting walls 19 projecting inwardly of the receptacle 14 in the lateral direction from the one or more respective side walls 16A. Specifically, the projecting wall 19 substantially extends in the front-rear direction.

The releasing portion 18 particularly substantially is formed to extend downward from (particularly a projecting end part of) the projecting wall 19. An end part (rear end part) of the releasing portion 18 disposed on the side of the first connector 11 particularly is substantially aligned with an opening end part of the receptacle 14.

### (Recesses 20)

The receptacle 14 includes one or more recesses 20 substantially extending in the front-rear direction. The one or more recesses 20 particularly are disposed adjacent to (particularly substantially above) the releasing portion(s) 18.

The recess 20 particularly is defined by the ceiling wall 16B, the projecting wall 19 and/or a coupling portion 21 coupling the ceiling wall 16B and the projecting wall 19 particularly substantially in the vertical direction.

The recess 20 particularly substantially is recessed in a direction from the inside toward the outside of the receptacle 14 in the lateral direction from the projecting end part of the projecting wall 19.

### (First Connector 11)

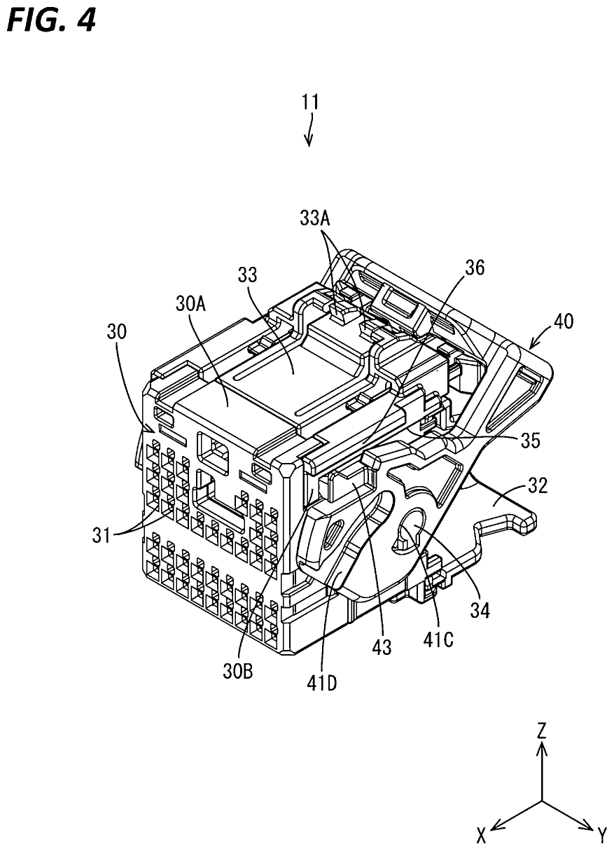

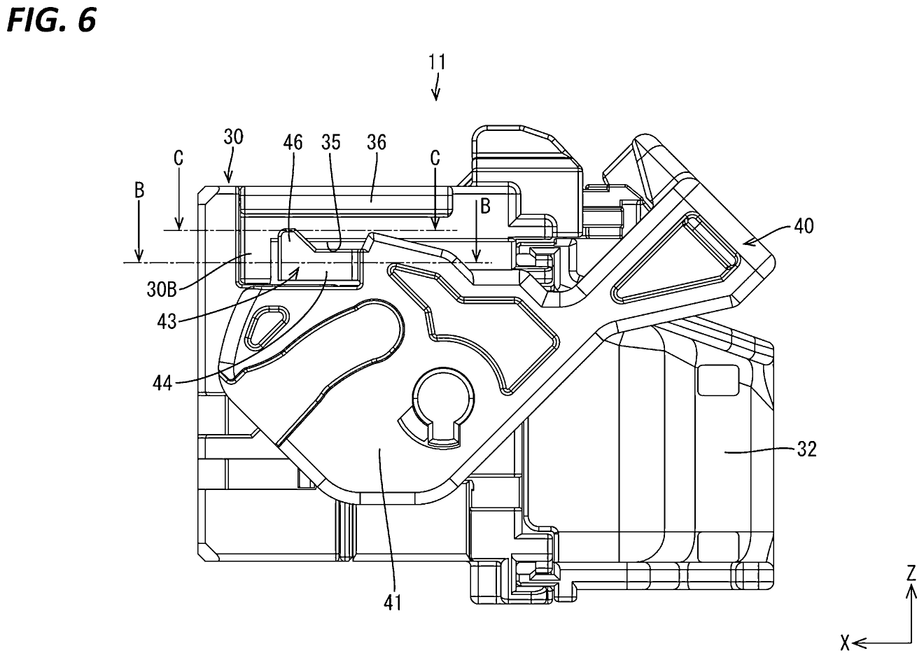

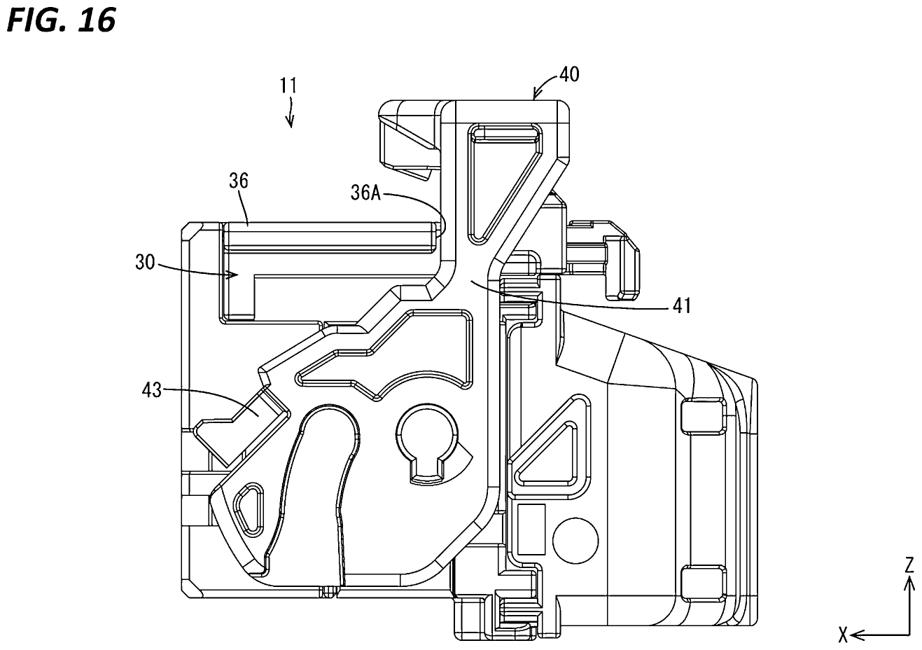

As shown in FIG. 4, the first connector 11 is provided with a housing 30 and a lever 40 (as an example of a displacement member). The lever 40 is mounted on the housing 30 displaceably (particularly rotatably or pivotably) between an initial position shown in FIG. 6 and a completion position shown in FIG. 16. A curved arrow A shown in FIG. 3 represents a displacement direction (particularly a rotation direction) RD from the initial position to the completion position.

In starting the connection of the first and second connectors 11, 12, the first and second connectors 11, 12 are lightly connected with the lever 40 arranged substantially at the initial position.

Then, the one or more cam pins 17 at least partly enter the one or more respective cam grooves 41D and/or are engaged with the inner wall(s) of the cam groove(s) 41D.

By displacing (particularly rotating or pivoting) the lever 40 towards or to the completion position with the cam pin(s) 17 and the inner wall(s) of the cam groove(s) 41D engaged, the connection of the first and second connectors 11, 12 is assisted or performed or completed.

### (Housing 30)

The housing 30 particularly at least partly is made of insulating synthetic resin.

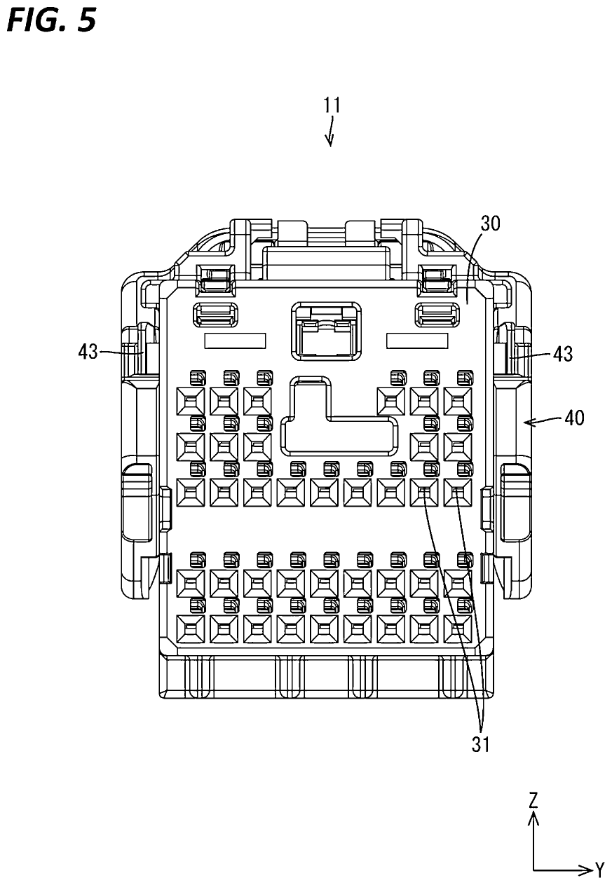

As shown in FIGS. 4 and 5, the housing 30 particularly has a substantially rectangular parallelepiped shape. The housing 30 includes one or more terminal accommodating portions 31 for at least partly accommodating one or more unillustrated first terminals. The one or more terminal accommodating portions 31 particularly are formed to penetrate through the housing 30 substantially in the front-rear direction.

The first terminal particularly substantially is made of electrically conductive material (such as metal) and includes a connecting portion (particularly a connecting tube portion) for at least partly receiving the second terminal 13.

An unillustrated wire is to be connected to the first terminal and/or drawn out substantially rearward from the housing 30.

As shown in FIGS. 4 and 6, a wire cover 32 for at least partly covering the one or more wires particularly is mounted on a rear end part of the housing 30.

As shown in FIG. 4, at least one lock arm 33 particularly is formed on (particularly an upper surface 30A of) the housing 30. The lock arm 33 particularly substantially extends along the the housing 30, particularly substantially rearward from a front part of the upper surface 30A of the housing 30.

The lock arm 33 is resiliently deformable substantially in a direction towards and away from the housing 30, particularly substantially in the vertical direction.

Specifically, the lock arm 33 includes a connection lock portion 33A substantially projecting outward (particularly upward) from the lock arm 33. The connection lock portion 33A is locked or lockable to the lever 40.

Specifically, the housing 30 includes one or more rotary shafts 34 substantially projecting outward in the lateral direction from one or more respective side surfaces 30B of the housing 30.

The rotary shaft 34 particularly has a substantially cylindrical shape.

By at least partly inserting the one or more rotary shafts 34 into one or more shaft holes 41C provided in the lever 40, the lever 40 is assembled with the housing 30. (Displacement Member, particularly Lever 40)

The lever 40 (as an example of a displacement member) particularly is made of insulating synthetic resin.

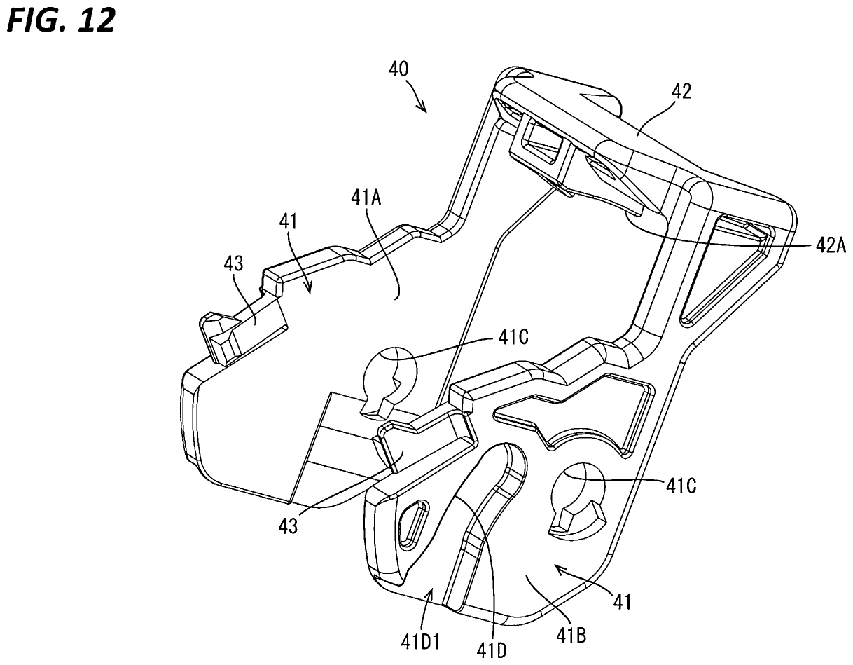

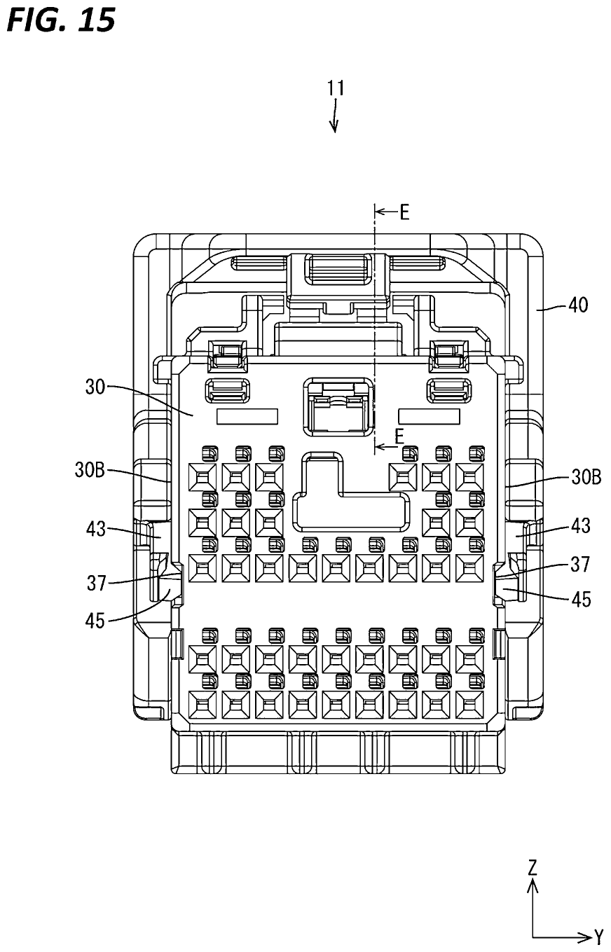

Specifically, as shown in FIG. 15, the lever 40 is substantially U-shaped as a whole. As shown in FIG. 12, the lever 40 includes one or more, particularly two (particularly substantially plate-like) portions 41, an operating portion 43 connecting (particularly end parts of) the two (plate-like) portions 41 and one or more lock pieces 43 extending from the respective (plate-like) portions 41.

The two plate-like portions 41 particularly are disposed to substantially face each other.

The plate-like portion 41 has an inner surface 41A disposed on an inner side of the lever 40 and an outer surface 40B disposed on a side opposite to the inner surface 41A.

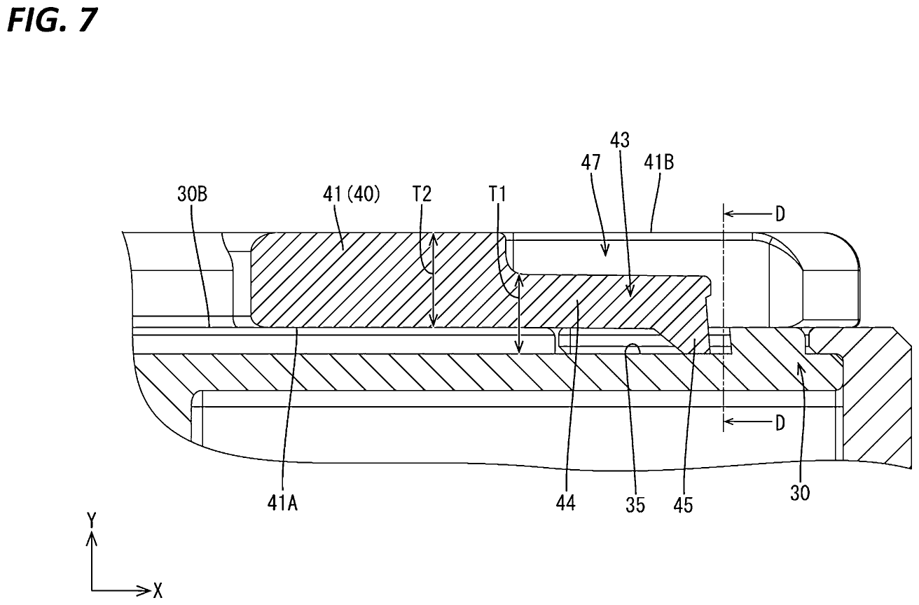

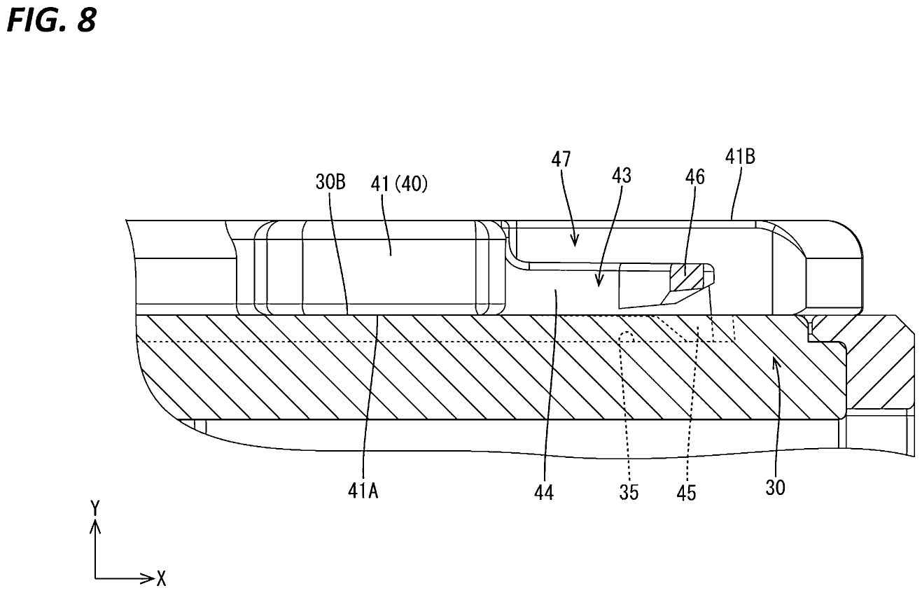

As shown in FIGS. 7 and 8, the inner surface 41A particularly substantially is disposed to face the side surface 30B of the housing 30.

As shown in FIG. 12, the (plate-like) portion 41 particularly is formed with the shaft hole 41C penetrating into or through the (plate-like) portion 41 and/or the cam groove 41D recessed in a thickness direction (lateral direction) of the (plate-like) portion 41 from the outer surface 41B of the plate-like portion 41.

As shown in FIG. 3, the cam groove 41D includes an entrance opening 41D1 in (particularly an outer edge part of) the plate-like portion 41, and/or extends in a substantially arcuate manner from the entrance opening 41D1 to approach the shaft hole 41C. The entrance opening 41D1 particularly is an opening for at least partly receiving the cam pin 17 into the cam groove 41D.

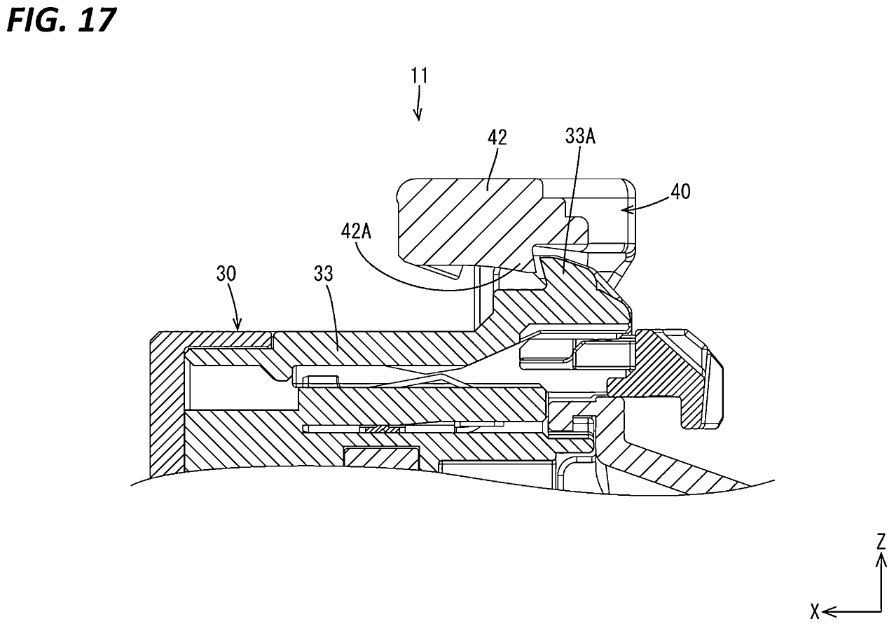

Specifically, as shown in FIG. 17, the lever 40 is provided with at least one connection lock receiving portion 42A projecting from the operating portion 42. The connection lock receiving portion 42A particularly is to engage or to be locked to the connection lock portion 33A.

In particular, in the process of displacing (particularly rotating or pivoting) the lever 40 (as an example of a displacement member) in the displacement direction (e.g. rotation direction) RD, the connection lock receiving portion 42A slides in contact with the connection lock portion 33A to deflect the lock arm 33 towards the housing 30 or substantially downward. When the lever 40 substantially reaches the completion position, the sliding contact of the connection lock receiving portion 42A and the connection lock portion 33A is released and the lock arm 33 returns towards or to a natural state. As a result, the connection lock receiving portion 42A and the connection lock portion 33A substantially face each other in the front-rear direction and/or are lockably disposed.

By locking the connection lock receiving portion 42A and the connection lock portion 33A, the lever 40 is positioned or held at the completion position.

### (Lock Piece 43, Lock Portion 45, Releasing Projection 46)

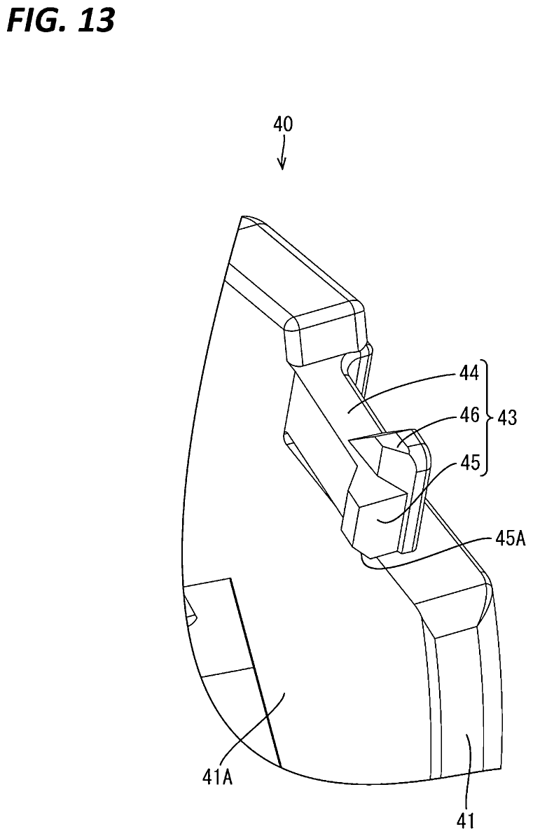

As shown in FIG. 13, the lock piece 43 particularly is provided with a body portion 44, at least one lock portion 45 and/or at least one releasing projection 46 particularly formed on or near a tip part of the body portion 44.

As shown in FIG. 6, the lock piece 43 particularly substantially extends forward with the lever 40 located at the initial position.

The releasing projection 46 particularly substantially projects upward (as an example of one side in the third direction) from the tip part of the body portion 44.

Specifically, as shown in FIG. 7, the lock portion 45 substantially projects in the lateral direction from the tip part of the body portion 44. In particular, the lock portion 45 substantially projects toward the housing 30 from the body portion 44.

### (Inclined Portion 45A)

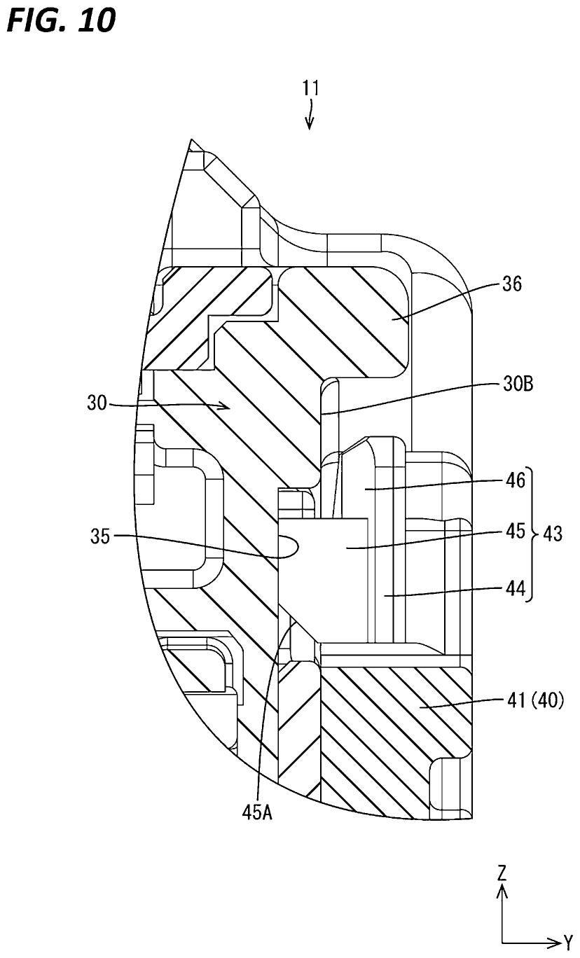

As shown in FIG. 10, the lock portion 45 includes an inclined portion 45A particularly substantially on a lower end part (as an example of an end part on the other side in the third direction) thereof with the lever 40 disposed at the initial position. The inclined portion 45A particularly substantially is inclined to reduce a projecting dimension from the body portion 44 toward a lower side.

### (Resilient Deformation Space 47)

As shown in FIG. 7, a thickness T1 (lateral dimension) of the lock piece 43 particularly is set to be smaller than a thickness T2 of the plate-like portion 41.

The lock piece 43 particularly is recessed from the outer surface 41B of the plate-like portion 41 and/or substantially formed into a step shape. The lock piece 43 particularly is formed to be continuous with the inner surface 41A of the plate-like portion 41 without any step.

A resilient deformation space 47 particularly is formed substantially outside the lock piece 43 and/or inwardly of the outer surface 41B of the plate-like portion 41 in the lateral direction.

### (Lock Receiving Portions 35)

As shown in FIGS. 4 and 6, the housing 30 particularly includes one or more lock receiving portions 35 substantially extending in the front-rear direction. The lock receiving portion 35 particularly is disposed at a position near an upper end part of the side surface 30B.

As shown in FIGS. 7, 8 and 10, the lock receiving portion 35 specifically is recessed from the (particularly each) side surface 30B.

With the lever 40 disposed at the initial position, the lock portion(s) 45 particularly are disposed in the lock receiving portion(s) 35 and/or the lock receiving portion(s) 35 and the lock portion(s) 45 are locked.

By locking the lock receiving portion(s) 35 and the lock portion(s) 45, the displacement (particularly rotation or pivotal movement) of the lever 40 in the rotation direction RD from the initial position particularly is suppressed. Further, as shown in FIGS. 8 and 10, the releasing projection 46 particularly is disposed apart from the side surface 30B in the lateral direction.

### (Protection Walls 36)

As shown in FIGS. 4 and 6, the housing 30 particularly includes one or more protection walls 36 substantially extending in the front-rear direction.

The protection wall(s) 36 is/are disposed above the lock receiving portion(s) 35. As shown in FIG. 10, the protection wall 36 particularly projects from the side surface 30B.

With the lever 40 located at the initial position, the protection wall 36 particularly is disposed to at least partly cover the lock piece 43 from outside or above.

The projecting end of the protection wall 36 is preferably disposed more outwardly of the housing 30 in the lateral direction than the lock piece 43. Further, the plate-like portion 41 particularly is disposed below the lock piece 43. Thus, the lock piece 43 particularly is disposed between the protection wall 36 and the plate-like portion 41 in the vertical direction.

Therefore, by particularly protecting the lock piece 43 by the protection wall 36 and/or the plate-like portion 41, it can be suppressed that the locking of the lock portion 45 and the lock receiving portion 35 is released.

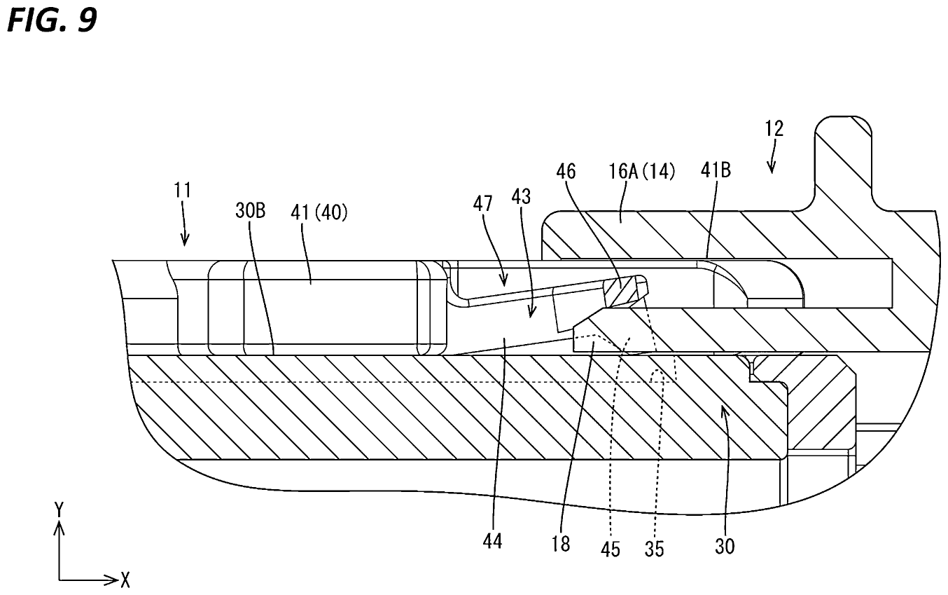

If the first and second connectors 11, 12 are lightly connected, the releasing portion 18 particularly interferes with the releasing projection 46 while being or sliding in contact with the side surface 30B as shown in FIG. 9. In this way, the lock piece 43 particularly is resiliently deformed away from the housing 30. As a result, the lock portion 45 is disposed outside the lock receiving portion 35 and the locking of the lock portion 45 and the lock receiving portion 35 is released.

The lock piece 43 particularly at least partly is resiliently deformed in the resilient deformation space 47 and/or accommodated to be closer to the side surface 30B than the outer surface 41B of the plate-like portion 41. Thus, by arranging the inner surface of the side wall 16A of the receptacle 14 in (particularly sliding) contact with the outer surface 41B of the plate-like portion 41, the receptacle 14 can be reduced in size in the lateral direction. Therefore, the second connector 12 including the receptacle 14 can be reduced in size in the lateral direction. On the other hand, if a lock piece is resiliently deformed to protrude outward from the outer surface of a plate-like portion unlike this embodiment, the inner surface of a side wall of a receptacle is disposed more outward than the outer surface of the plate-like portion so that the lock piece does not interfere with the inner surface of the side wall. As a result, lateral dimensions of the receptacle and a second connector are larger than in this embodiment.

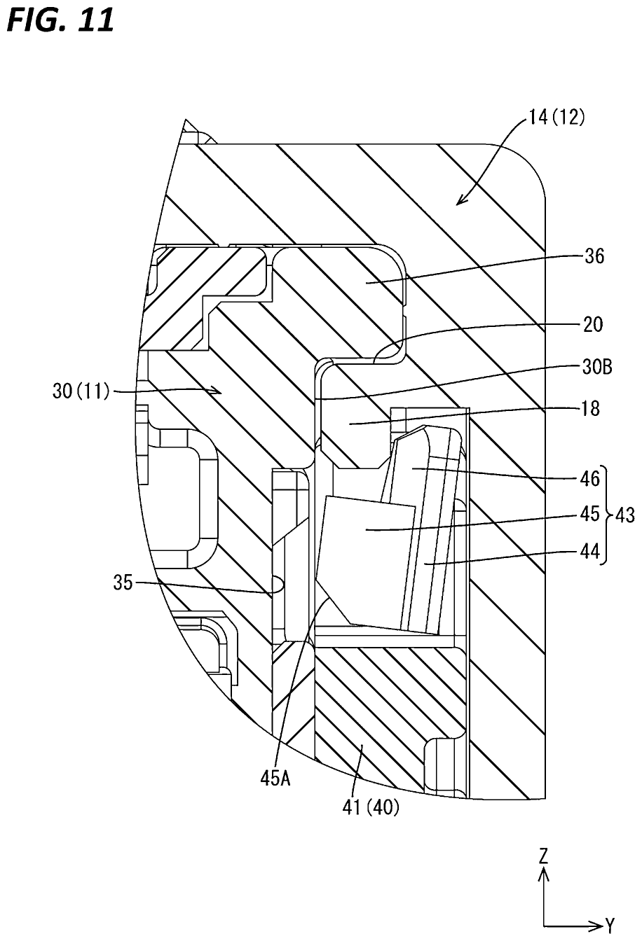

As shown in FIG. 11, since the releasing portion 18 particularly interferes with the releasing projection 46 disposed in an upper part of the lock piece 43, the amount of resilient deformation of the lock piece 43 particularly increases in the upper part of the lock piece 43 while decreasing in a lower part of the lock piece 43. That is, the lock piece 43 particularly is twisted and deformed to rotate about an axis extending in the front-rear direction (direction perpendicular to the plane of FIG. 11). Thus, a lower part of the lock portion 45 having a small amount of resilient deformation does not exit from the inside of the lock receiving portion 35 and/or the locking of the lock portion 45 and the lock receiving portion 35 is possibly not completely released.

However, since the inclined portion 45A particularly is formed in the lower end part of the lock portion 45 in this embodiment, the locking of the lock portion 45 and the lock receiving portion 35 is easily released by the interference of the releasing portion 18 with the releasing projection 46.

As shown in FIG. 3, since the releasing portion 18 particularly interferes with the releasing projection 46 substantially from front, the releasing projection 46 receives an acting force in a substantially opposing direction, particularly a rearward (rightward in FIG. 3) acting force.

Since the one or more releasing projections 46 particularly are disposed obliquely outside or above (on an oblique left upper side in FIG. 3) the rotary shafts 34, the lever 40 is going to be displaced in a direction substantially opposite to the rotation direction RD, e.g. rotate clockwise in FIG. 3.

On the other hand, the rotation direction RD, which is a direction of rotating the lever 40 in connecting the first and second connectors 11, 12, is a counterclockwise direction in FIG. 3. Thus, the displacement (rotation or pivotal movement) of the lever 40 in the rotation direction RD by forces received from the releasing portion(s) 18 is suppressed if the locking of the lock piece(s) 43 (lock portion(s) 45) and the lock receiving portion(s) 35 is released by the releasing portion(s) 18. Accordingly, it can be suppressed that a worker who connects the first and second connectors 11, 12 erroneously recognizes the completion of the connecting operation of the first and second connectors 11, 12 after lightly connecting the first and second connectors 11, 12 and/or releasing the locking of the lock portion(s) 45 and the lock receiving portion(s) 35. Then, the worker can recognize necessity to further connect the first and second connectors 11, 12 by rotating the lever 40 in the rotation direction RD.

In the process of connecting the first and second connectors 11, 12, the one or more protection walls 36 particularly are engaged with the one or more recesses 20 as shown in FIG. 11. In this way, the connection of the first and second connectors 11, 12 is guided.

### (Contact Portion 36A)

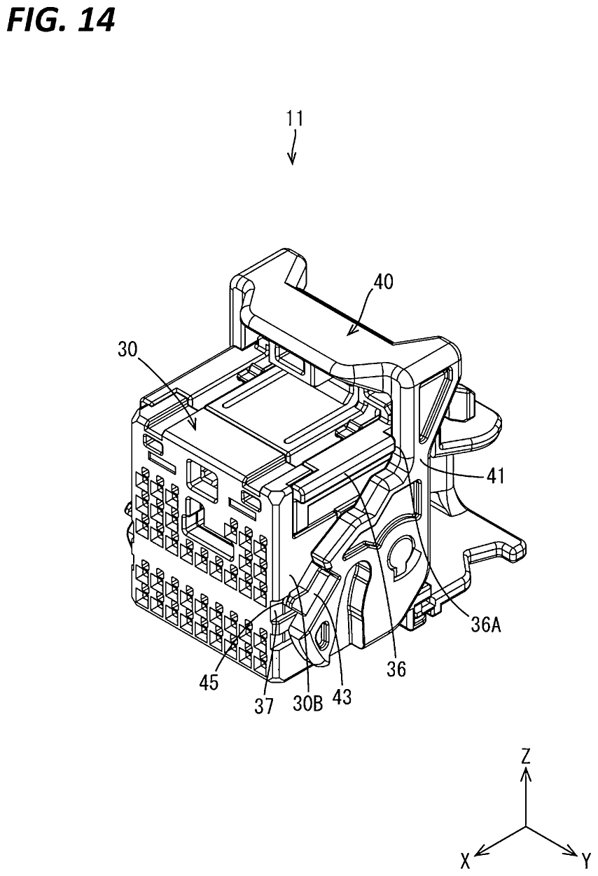

As shown in FIGS. 14 and 16, the protection wall 36 particularly includes at least one contact portion 36A specifically on a rear end part thereof. With the lever 40 disposed at the completion position, the one or more contact portions 36A are in contact with the one or more plate-like portions 41 from front. The displacement (particularly rotation or pivotal movement) of the lever 40 in the rotation direction RD further than the completion position can be suppressed by the contact of the contact portion(s) 36A with the plate-like portion(s) 41.

As shown in FIGS. 14 and 15, at least one completion recess 37 recessed from the side surface 30B particularly is formed in or near a front end part of (particularly a lower part of) the side surface 30B. The completion recess 37 particularly at least partly accommodates the lock portion 45 with the lever 40 disposed at the completion position.

### Functions and Effects of Embodiment

(1) The connector assembly 10 according to the embodiment is provided with the first connector 11 and the second connector 12 to be connected to the first connector 11, the first connector 11 includes the housing 30 and the lever 40 to be mounted on the housing 30 displaceably (particularly rotatably or pivotally) between the initial position and the completion position, the housing 30 includes the one or more lock receiving portions 35, the lever 40 particularly includes the one or more lock pieces 43 for holding the lever 40 at the initial position by locking the lock receiving portion(s) 35, the one or more lock pieces 43 particularly are resiliently deformable, the second connector 12 includes the one or more releasing portions 18 for releasing the locking of the one or more lock pieces 43 and one or more the lock receiving portions 35 by being or sliding in contact with the one or more lock pieces 43 when the connection of the first and second connectors 11, 12 is started, and the lever 40 receives a force acting in a direction substantially opposite to the rotation direction RD from the initial position to the completion position when the releasing portions 18 and the lock pieces 43 are or slide in contact.

According to this configuration, when the locking of the lock piece(s) 43 and the lock receiving portion(s) 35 is released by the releasing portion(s) 18, the displacement (particularly rotation or pivotal movement) of the lever 40 in the rotation direction RD from the initial position toward the completion position can be suppressed.

(2) In the embodiment, the direction of connecting the first and second connectors 11, 12 particularly is the first direction (e.g. front-rear direction), the first connector 11 is connected to the second connector 12 from one side (e.g. rear side) in the first direction, the lever 40 includes the one or more plate-like portions 41 displaceably (rotatably or pivotally) supported on the side surface(s) 30B of the housing 30 and the lock piece(s) 43 substantially extending toward the other side (e.g. front side) in the first direction from the plate-like portion(s) 41 with the lever 40 located at the initial position.

Specifically, the lock piece 43 includes the body portion 44, the lock portion 45 projecting from (particularly the tip part of) the body portion 44 in the second direction (e.g. lateral direction) at an angle different from 0° or 180°, particularly substantially orthogonal to the first direction and/or the releasing projection 46 substantially projecting from the body portion 44 (particularly from or near the tip part of the body portion 44) on one side (upper side) in the third direction at an angle different from 0° or 180°, particularly substantially orthogonal to both the first and second directions.

Further specifically, the releasing portion(s) 18 and the releasing projection(s) 46 substantially slide in contact, whereby the lock piece(s) 43 is/are resiliently deformed away from the side surface(s) 30B in the second direction.

Particularly, the lock portion 45 includes the inclined portion 45A disposed on the end part (lower end part) on the other side in the third direction, and the projecting dimension of the inclined portion 45A from the body portion 44 particularly is reduced toward the other side (lower side) in the third direction.

According to this configuration, if the lock piece 43 is resiliently deformed to being displaced (e.g. rotate) about the axis extending in the first direction by the (particularly sliding) contact of the releasing portion 18 and the releasing projection 46, the locking of the lock portion 45 and the lock receiving portion 35 is easily released.

(3) In the embodiment, the thickness T1 of the lock piece 43 particularly is set to be smaller than the thickness T2 of the plate-like portion 41.

Further particularly, the at least one resilient deformation space 47 is formed inwardly of the outer surface 41B of the plate-like portion 41, and the lock piece 43 is resiliently deformed inside the resilient deformation space 47, whereby the locking of the lock portion 45 and the lock receiving portion 35 is released.

According to this configuration, since the lock piece 43 is not disposed more outward in the second direction than the plate-like portion 41 when being resiliently deformed, a dimension of the second connector 12 in the second direction can be reduced when the second connector 12 is connected to the first connector 11 from outside.

(4) In the embodiment, the housing 30 particularly includes the protection wall(s) 36 substantially projecting in the second direction from the side surface(s) 30B and/or substantially extending in the first direction, and the one or more lock pieces 43 at least partly are disposed between the protection wall(s) 36 and the plate-like portion(s) 41 substantially in the third direction.

According to this configuration, the lock piece(s) 43 can be protected by the protection wall(s) 36 and/or it can be suppressed that the locking of the lock portion(s) 45 and the lock receiving portion(s) 35 is released.

(5) In the embodiment, the protection wall 36 includes the contact portion 36A for contacting the plate-like portion 41 from the other side in the first direction with the lever 40 located at the completion position.

According to this configuration, the displacement (e.g. rotation) of the lever 40 in the rotation direction RD further than the completion position particularly can be suppressed by the contact of the contact portion(s) 36A with the plate-like portion(s) 41.

(6) In the embodiment, the second connector 12 particularly includes the one or more recesses 20 for at least partly receiving the one or more protection walls 36 by substantially extending in the first direction.

According to this configuration, the connection of the first and second connectors 11, 12 can be guided by the one or more recesses 20 at least partly receiving the one or more protection walls 36.

### Other Embodiments

The above embodiment can be modified and carried out as follows. The above embodiment and the following modifications can be carried out in combination without technically contradicting each other.
Although the lock portion 45 includes the inclined portion 45A in the above embodiment, a lock portion may include no inclined portion.
Although the lock piece 43 is resiliently deformed on the further inner side than the outer surface 41B of the plate-like portion 41 in the above embodiment, a lock piece may be resiliently deformed further outward than the outer surface of a plate-like portion.
Although the housing 30 includes the one or more protection walls 36 in the above embodiment, a housing may include no protection walls.
Although the first connector 11 particularly includes the wire cover 32 in the above embodiment, a first connector may include no wire cover.

Although in the above described connector assembly 10 the first connector 11 is provided with the lever 40 (as an exemplary displacement member) being rotatably or pivotably mounted to the housing 30, it should be understood that any other configuration of a displacement member other than a rotatable or pivotable lever may be adopted, such as a sliding member displaceably arranged on or in the housing 30 (e.g. displaceable along a substantially linear or non-linear path) such as to be able to assist the connection/separation of the first connector 11 and the second connector 12 by a cam action displayed by the displacement thereof, e.g. by a cam action displayed while displacing the displacement member between a cam member provided on the housing and a cooperating cam member provided on the displacement member (e.g. similar to the cam pin 17 and the cam groove 41D described above).

Accordingly, to suppress the displacement (e.g. rotation or pivotal movement) of a displacement member (such as a lever) from an initial position toward a completion position when a first connector and a second connector are lightly connected, there is provided a connector assembly 10 being provided with a first connector 11 and a second connector 12 to be connected to the first connector 12. The first connector 11 includes a housing 30 and a displacement member (such as a lever) 40 to be mounted on the housing 30 displaceably (e.g. rotatably or pivotally) between an initial position and a completion position. The housing 30 includes a lock receiving portion 35. The displacement member (such as the lever) 40 includes a lock piece 43 for holding the displacement member (such as the lever) 40 at the initial position by locking the lock receiving portion 35. The lock piece 43 is resiliently deformable. The second connector 12 includes a releasing portion 18 for releasing locking of the lock piece 43 and the lock receiving portion 35 by substantially sliding in contact with the lock piece 43 when the connection of the first and second connectors 11, 12 is started. The displacement member (such as the lever) 40 receives a force acting in a direction opposite to a displacement direction (such as a rotation direction) RD from the initial position toward the completion position when the releasing portion 18 and the lock piece 43 slide in contact.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector assembly (10), comprising:
a first connector (11); and
a second connector (12) to be connected to the first connector (11),
the first connector (11) including a housing (30) and a displacement member (40) to be mounted on the housing (30) displaceably between an initial position and a completion position,
the housing (30) including at least one lock receiving portion (35),
the displacement member (40) including at least one lock piece (43) for holding the displacement member (40) at the initial position by locking the lock receiving portion (35),
the lock piece (43) being resiliently deformable,
the second connector (12) including at least one releasing portion (18) for releasing locking of the lock piece (43) and the lock receiving portion (35) by substantially sliding in contact with the lock piece (43) when connection of the first and second connectors (11, 12) is started, and
the displacement member (40) receiving a force acting in a direction substantially opposite to a displacement direction (RD) from the initial position toward the completion position when the releasing portion (18) and the lock piece (43) slide in contact.

2. The connector assembly according to claim 1, wherein:
a direction of connecting the first and second connectors (11, 12) is a first direction,
the first connector (11) is connected to the second connector (12) from one side in the first direction,
the displacement member (40) includes at least one plate-like portion (41) to be displaceably supported on a side surface of the housing (30B) and the lock piece (43) substantially extending toward the other side in the first direction from the plate-like portion (41) with the displacement member (40) located at the initial position, and
the lock piece (43) includes a body portion (44), at least one lock portion (45) substantially projecting from or near a tip part of the body portion (44) in a second direction intersecting with, particularly orthogonal to the first direction and at least one releasing projection (46) projecting from the body portion (44) toward one side in a third direction intersecting with, particularly orthogonal to both the first and second directions.

3. The connector assembly according to claim 2, wherein the releasing portion (18) and the releasing projection (46) substantially slide in contact, whereby the lock piece (43) is resiliently deformed away from the side surface (30B) in the second direction.

4. The connector assembly according to claim 2, wherein the lock portion (45) includes at least one inclined portion (45A) disposed on or near an end part on the other side in the third direction, and
a projecting dimension of the inclined portion (45A) from the body portion (44) is reduced toward the other side in the third direction.

5. The connector assembly according to claim 3, wherein:
a thickness (T1) of the lock piece (43) is set to be smaller than a thickness (T2) of the plate-like portion (41),
at least one resilient deformation space (47) is formed on a further inner side than an outer surface (41B) of the plate-like portion (41), and
the lock piece (43) is resiliently deformed inside the resilient deformation space (47), whereby locking of the lock portion (45) and the lock receiving portion (35) is released.

6. The connector assembly according to claim 2, wherein:
the housing (30) includes at least one protection wall (36) substantially projecting in the second direction from the side surface (30B) and substantially extending in the first direction, and
the lock piece (43) at least partly is disposed between the protection wall (36) and the plate-like portion (41) substantially in the third direction.

7. The connector assembly according to claim 6, wherein the protection wall (36) includes at least one contact portion (36A) for contacting the plate-like portion (41) from the other side in the first direction with the displacement member (40) located at the completion position.

8. The connector assembly according to claim 6, wherein the second connector (12) includes at least one recess (20) for at least partly receiving the protection wall (36) by substantially extending in the first direction.

9. An assembly method for connecting a first connector (11) and a second connector (12), comprising the following steps:
mounting a displacement member (40) on a housing (30) of the first connector (11) displaceably between an initial position and a completion position, wherein the housing (30) includes at least one lock receiving portion (35),
holding the displacement member (40) at the initial position by locking the lock receiving portion (35) with at least one lock piece (43) of the displacement member (40), wherein the lock piece (43) is resiliently deformable,
providing the second connector (12) with at least one releasing portion (18) for releasing locking of the lock piece (43) and the lock receiving portion (35) by substantially sliding in contact with the lock piece (43) when connection of the first and second connectors (11, 12) is started, and
applying a force to the displacement member (40), the force acting in a direction substantially opposite to a displacement direction (RD) from the initial position toward the completion position when the releasing portion (18) and the lock piece (43) slide in contact.

10. The assembly method according to claim 9, wherein the first and second connectors (11, 12) are connected in a first direction, the first connector (11) is connected to the second connector (12) from one side in the first direction,
the method further comprising:
providing the displacement member (40) with at least one plate-like portion (41) to be displaceably supported on a side surface of the housing (30B) and the lock piece (43) substantially extending toward the other side in the first direction from the plate-like portion (41) with the displacement member (40) located at the initial position, and
providing the lock piece (43) with a body portion (44), at least one lock portion (45) substantially projecting from or near a tip part of the body portion (44) in a second direction intersecting with, particularly orthogonal to the first direction and at least one releasing projection (46) projecting from the body portion (44) toward one side in a third direction intersecting with, particularly orthogonal to both the first and second directions.
